(19) United States
(12) Patent Application Publication
(10) Pub. No.: US 2016/0350578 A1
(43) Pub. Date: Dec. 1, 2016

(54) FINGERPRINT IDENTIFICATION DEVICE AND ELECTRONIC DEVICE USING SAME

(71) Applicant: HON HAI PRECISION INDUSTRY CO., LTD., New Taipei (TW)

(72) Inventor: Jen-Tsorng CHANG, New Taipei (TW)

(21) Appl. No.: 14/848,531

(22) Filed: Sep. 9, 2015

(30) Foreign Application Priority Data
May 27, 2015 (CN) 201510277150.1

(51) Int. Cl. G06K 9/00; G01L 5/00

(52) U.S. Cl. CPC G06K 9/00013; G06K 9/00087; G01L 5/0038

(57) ABSTRACT

The present disclosure relates to a fingerprint identification device includes a pressure sensor array, a multiplexer, an addressing circuit, a signal processing circuit, a microcontroller and a memory. The multiplexer is connected to the pressure sensor array and the signal processing circuit. The microcontroller is connected to the signal processing circuit and the memory. The addressing circuit is connected to the multiplexer and the microcontroller. The microcontroller includes a timing unit, a location identification unit, an image processor and a comparing unit, the timing unit. The location identification unit and the image processor are used to process electrical signals received by the microcontroller to gain location information, fingerprint images, durations and a set of fingerprint information corresponding to the electrical signal. The microcontroller gives out a fingerprint identification confirmation or fingerprint unconformable information according to the comparison result gained by the comparing unit.

### FIELD

The subject matter herein generally relates to a fingerprint identification device and an electronic device using same.

### BACKGROUND

Short-haul payments or online payments on mobile devices are applied to online shopping. It is essential to identify a user for short-haul payments or online payments. At present, identity recognition mainly adopts fingerprint identification and password identification.

### BRIEF DESCRIPTION OF THE DRAWINGS

Implementations of the present technology will now be described, by way of example only, with reference to the attached figures.

FIG. 1 is a diagrammatic view of a fingerprint identification device of the disclosure.

FIG. 2 is a cross sectional view of a pressure sensor of the fingerprint identification device of FIG. 1.

FIG. 3 is a block diagram view of a microcontroller of the fingerprint identification device of FIG. 1.

FIG. 4 is an isometric view of an electronic device using the fingerprint identification device of FIG. 1.

FIG. 5 is a cross sectional view taken along V-V line of the electronic device of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

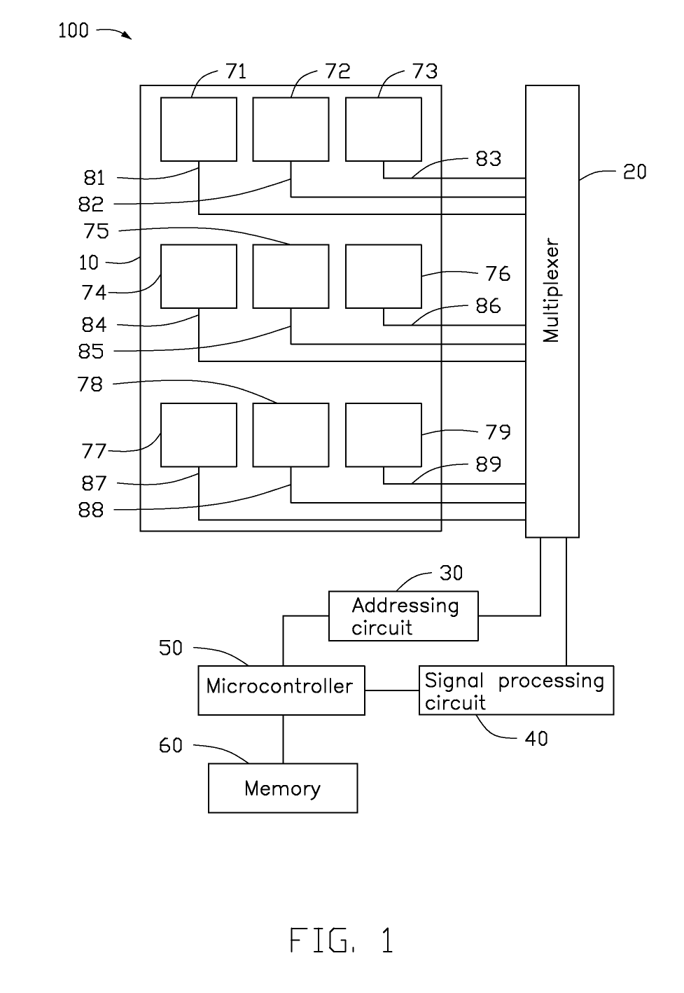

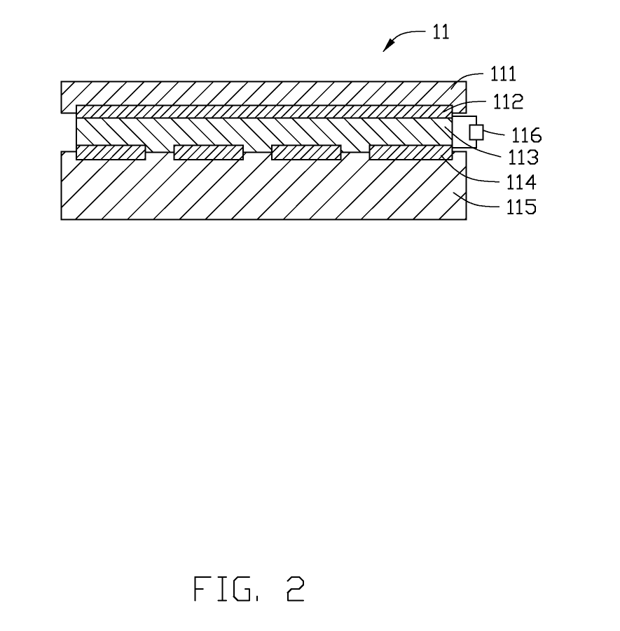

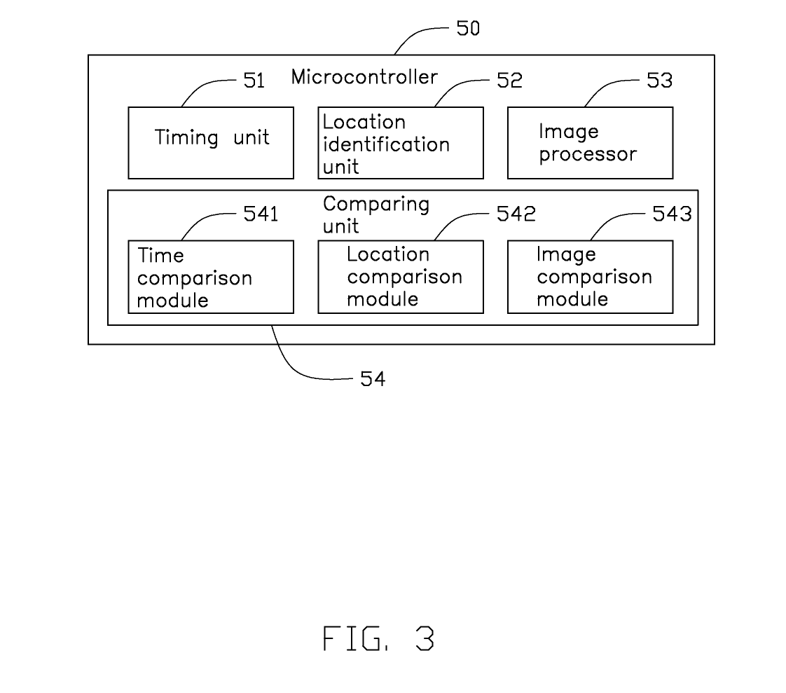

Referring to FIGS. 1-3, a fingerprint identification device 100 of an embodiment of the present disclosure includes a pressure sensor array 10, a multiplexer 20, an addressing circuit 30, a signal processing circuit 40, a microcontroller 50 and a memory 60.

The pressure sensor array 10 includes several pressure sensors 11 and several connecting lines connected to the corresponding pressure sensors 11.

The several pressure sensors 10 are arranged to a m×n matrix. Each of the several pressure sensors 10 includes a first base 111, a first electrode layer 112, a pressure layer 113, a second electrode layer 114, a second base 115 and a circuit 116. The first base 111, the first electrode layer 112, the pressure layer 113, the second electrode layer 114 and the second base 115 form a cascade of a structure. The first electrode layer 112 is between the first base 111 and the pressure layer 113, and the first electrode layer 112 is connected to the first base 111 and the pressure layer 113. The second electrode layer 114 is between the pressure layer 113 and the second base 115, and the second electrode layer 114 is connected to the pressure layer 113 and the second base 115. The circuit 116 is electrically connected to the first electrode layer 112 and the second the electrode layer 114. When a pressure is inflicted on the pressure layer 113, the circuit 116 can detect a voltage change between the first electrode layer 112 and the second the electrode layer 114. In the embodiment, the pressure sensor 11 is made of piezoelectric polymer materials. In other embodiments, the pressure sensor 11 can be made of carbon nanotubes.

In the embodiment, the several pressure sensors 11 of the pressure sensor array 10 are divided into a first sensing unit 71, a second sensing unit 72, a third sensing unit 73, a fourth sensing unit 74, a fifth sensing unit 75, a sixth sensing unit 76, a seventh sensing unit 77, a eighth sensing unit 78 and a ninth sensing unit 79. The first sensing unit 71, the second sensing unit 72, the third sensing unit 73, the fourth sensing unit 74, the fifth sensing unit 75, the sixth sensing unit 76, the seventh sensing unit 77, the eighth sensing unit 78 and the ninth sensing unit 79 are arranged to a 3×3 matrix.

In the embodiment, each of the first sensing unit 71, the second sensing unit 72, the third sensing unit 73, the fourth sensing unit 74, the fifth sensing unit 75, the sixth sensing unit 76, the seventh sensing unit 77, the eighth sensing unit 78 and the ninth sensing unit 79 includes multiple pressure sensors 11. The distance between the ridges of a finger is about 400-500 micrometers. In the embodiment, the distance of the pressure sensors 11 of the pressure sensor array 10 is far less than 400 micrometers, optimally less than 100 micrometers.

The several connecting lines includes a first connecting line 81, a second connecting line 82, a third connecting line 83, a fourth connecting line 84, a fifth connecting line 85, a sixth connecting line 86, a seventh connecting line 87, a eighth connecting line 88 and a ninth connecting line 89. The first connecting line 81 is connected to the pressure sensors 11 of the first sensing unit 71. The second connecting line 82 is connected to the pressure sensors 11 of the second sensing unit 72. The third connecting line 83 is connected to the pressure sensors 11 of the third sensing unit 73. The fourth connecting line 84 is connected to the pressure sensors 11 of the fourth sensing unit 74. The fifth connecting line 85 is connected to the pressure sensors 11 of the fifth sensing unit 75. The sixth connecting line 86 is connected to the pressure sensors 11 of the sixth sensing unit 76. The seventh connecting line 87 is connected to the pressure sensors 11 of the seventh sensing unit 77. The eighth connecting line 88 is connected to the pressure sensors 11 of the eighth sensing unit 78. The ninth connecting line 89 is connected to the pressure sensors 11 of the ninth sensing unit 79.

The microcontroller 50 includes a timing unit 51, a location identification unit 52, an image processor 53 and a comparing unit 54. The comparing unit 54 includes a time comparison module 541, a location comparison module 542 and an image comparison module 543.

The first connecting lines 81, the second connecting lines 82, the third connecting lines 83, the fourth connecting lines 84, the fifth connecting lines 85, the sixth connecting lines 86, the seventh connecting lines 87, the eighth connecting lines 88 and the ninth connecting lines 89 are connected to the multiplexer 20. The signal processing circuit 40 is coupled to the multiplexer 20 and the microcontroller 50. The addressing circuit 30 is connected to the multiplexer 20 and the microcontroller 50. The memory 60 is connected to the microcontroller 50. The microcontroller 50 controls the multiplexer 20 to process in multiplex sets by the addressing circuit 30.

When a fingerprint information is set in the fingerprint identification device 100, a finger of the user touches one or several of the first sensing unit 71, the second sensing unit 72, the third sensing unit 73, the fourth sensing unit 74, the fifth sensing unit 75, the sixth sensing unit 76, the seventh sensing unit 77, the eighth sensing unit 78 and the ninth sensing unit 79.

As grains of surface skin of the finger are ridged, the pressure sensors 11 located between the ridges of the finger sense small pressures, even zero pressures. The pressure sensors 11 located on the ridges of the finger sense large pressures. The fingerprint identification device 100 can acquire fingerprint information of the finger act on the pressures sensor array 10 according to the pressure difference sensed by the pressure sensors 11. Pressure information sensed by the pressure sensors 11 is transferred to the multiplexer 20 by the first connecting line 81, the second connecting line 82, the third connecting line 83, the fourth connecting line 84, the fifth connecting line 85, the sixth connecting line 86, the seventh connecting line 87, the eighth connecting line 88 and the ninth connecting line 89. The multiplexer 20 transfers the pressure information to the signal processing circuit 40. The signal processing circuit 40 transfers the pressure information into electrical signal and sends the electrical signal to the microcontroller 50. The timing unit 51 of the microcontroller 50 records duration of the pressure signal corresponding to the electrical signal, the location identification unit 52 processes the electrical signal to gain a location information of the pressure sensors 11 that sense the pressure signal. The image processor 53 processes the electrical signal to gain a fingerprint image of the finger acted on the pressures sensor array 10.

In the embodiment, the duration of the pressure signal, the location and the fingerprint image corresponding to one electrical signal form a set of fingerprint information. The microcontroller 50 controls the memory 60 to record all the preset fingerprint information according to the receive sequence of the corresponding electrical signal by the memory 60. The preset fingerprint information stored in the memory comprises preset time information, preset location information, and preset fingerprint image.

When identifying a fingerprint, the finger of the user touches one of the first sensing unit 71, the second sensing unit 72, the third sensing unit 73, the fourth sensing unit 74, the fifth sensing unit 75, the sixth sensing unit 76, the seventh sensing unit 77, the eighth sensing unit 78 and the ninth sensing unit 79 in turn. The multiplexer 20 sends the corresponding pressure signal to the signal processing circuit 40. The signal processing circuit 40 transfers the corresponding pressure signals into the electrical signals and sends the electrical signal to the microcontroller 50, the microcontroller 50 processes the electrical signal to gain the fingerprint images, the duration of the pressure signals and the location information of the pressure sensors 11 that senses the pressure signals.

The comparing unit 54 of the microcontroller 50 compares all the fingerprint images, the duration of the pressure signals and the location information of the pressure sensors 11 that senses the pressure signals with the preset fingerprint information stored in the memory 60. When microcontroller 50 contrasts the fingerprint images, the duration of the pressure signals and the location information of the pressure sensors 11 that senses the pressure signals corresponding to one electrical signal, the time comparison module 541 of the comparing module 54 compares the duration of the pressure signals with the preset time information stored in the memory 60. The location comparison module 542 compares the location information of the pressure sensors 11 that senses the pressure signals with the preset location information stored in the memory 60. The image comparison module 543 compares the fingerprint image with the preset fingerprint image stored in the memory 60. The comparing unit 54 compares the fingerprint images, the duration of the pressure signals and the location information of the pressure sensors 11 that senses the pressure signals with all the preset fingerprint information stored in the memory 60 in sequence.

When the similarity between the preset fingerprint information stored in the memory 60 and the fingerprint information input by the user is bigger than a predetermined value of the microcontroller 50, the microcontroller 50 gives out a fingerprint identification confirmation information. When the similarity between the preset fingerprint information stored in the memory 60 and the fingerprint information input by the user is smaller than the predetermined value, the microcontroller 50 gives out a information that the fingerprint information is not conformity.

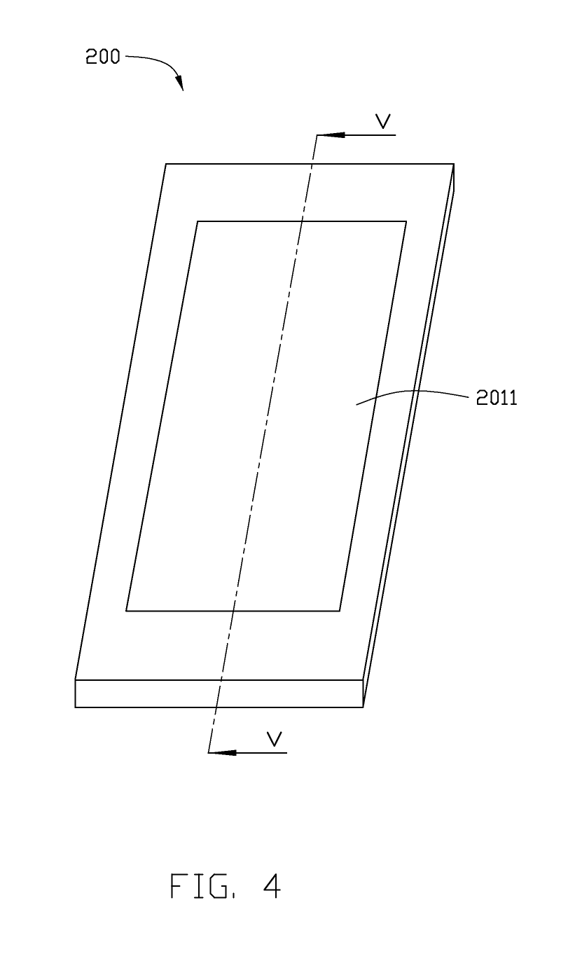

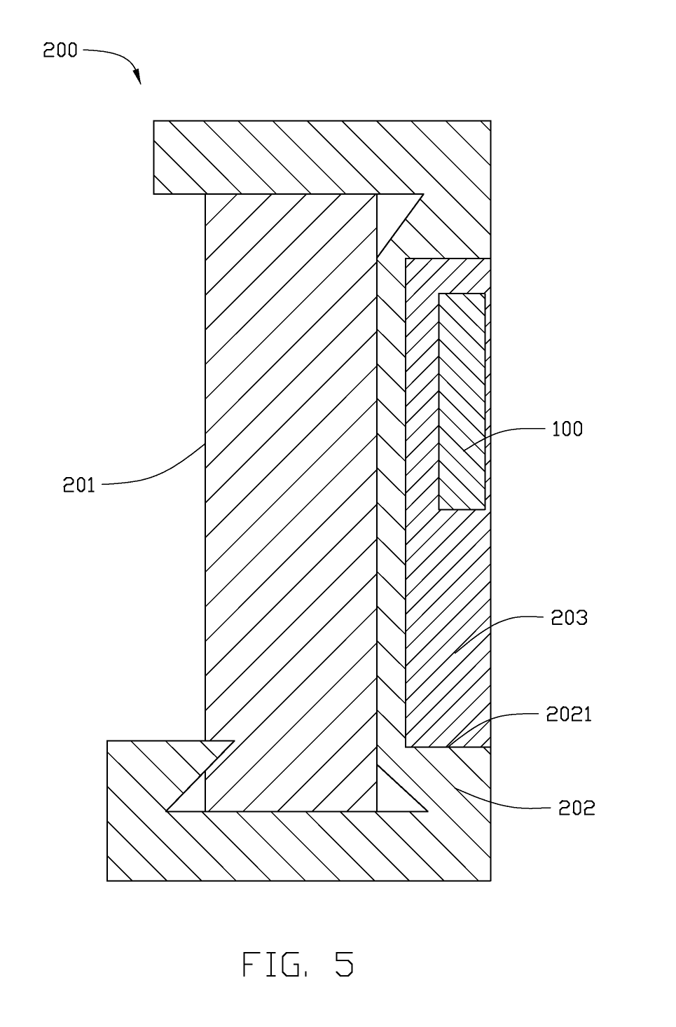

Referring to FIGS. 4-5, an electronic device 200 of an embodiment of the present disclosure includes the fingerprint identification device 100, a display panel 201, a shell 202 and a back board 203. The display panel 201 is substantially rectangular-shaped, and the display panel 201 is located on a side of the shell 202. The display panel 201 includes a display surface 2011, the display surface 2011 is far away from the shell 202. Other side of the shell 202 defines a groove 2021 corresponding to the display panel 201. The back board 203 is housed in the groove 2021 of the shell 202, the fingerprint identification device 100 is located in the back board 203. In the embodiment, the back board 203 is made from plastic, and the back board 203 is substantially undee-shaped.

In operation of the electronic device 200, the finger of the user touches the display surface 2011 of the display 201, the pressure imposed by the finger is transferred to the fingerprint identification device 100 through the display 201, the shell 202 and the back board 203. The fingerprint identification device 100 begins to work after receiving the pressure.

The embodiments shown and described above are only examples. Many details are often found in the art such as the other features of a fingerprint identification device and an electronic device using the fingerprint identification device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A fingerprint identification device comprising:
a pressure sensor array;
a signal processing circuit coupled to the pressure sensor array by a multiplexer;
an addressing circuit connected to the multiplexer;
a memory configured for storing preset fingerprint information; and
a microcontroller connected to the signal processing circuit, the addressing circuit, and the memory, the microcontroller comprising:
a timing unit, a location identification unit, an image processor, and a comparing unit, wherein the timing unit, the location identification unit and the image processor are used to process electrical signals received by the microcontroller to acquire location information, fingerprint images, durations and a set of fingerprint information comprising the location information, the fingerprint images and the durations corresponding to the electrical signal,
wherein the comprising unit compares all the fingerprint information corresponding to the electrical signals with preset fingerprint information stored in the memory in turn, the microcontroller gives out a fingerprint identification confirmation or fingerprint unconformable information according to the comparison result acquired by the comparing unit.

2. The fingerprint identification device of claim 1, wherein the microcontroller controls the multiplexer to process in multiplex sets by the addressing circuit.

3. The fingerprint identification device of claim 2, wherein the signal processing circuit transfers the pressure information received by the pressure sensor array into electrical signal and sends the electrical signal to the microcontroller, the timing unit of the microcontroller records duration of the pressure signal corresponding to the electrical signal, the location identification unit processes the electrical signal to gain a location information of pressure sensors of the pressures sensor array that sense the pressure signal, the image processor processes the electrical signal to gain a fingerprint image of the finger acted on the pressures sensor array.

4. The fingerprint identification device of claim 3, wherein the comparing unit comprises a time comparison module, a location comparison module and an image comparison module, the preset fingerprint information stored in the memory comprises preset time information, preset location information, and preset fingerprint image, the time comparison module compares the duration of the pressure signals with the preset time information stored in the memory, the location comparison module compares the location information of the pressure sensors that senses the pressure signals with the preset location information stored in the memory, the image comparison module compares the fingerprint image with the preset fingerprint image stored in the memory.

5. The fingerprint identification device of claim 1, wherein the pressure array comprises several pressure sensors, a first connecting line, a second connecting line, a third connecting line, a fourth connecting line, a fifth connecting line, a sixth connecting line, a seventh connecting line, a eighth connecting line and a ninth connecting line, the several pressure sensors are arranged to a m×n matrix.

6. The fingerprint identification device of claim 5, wherein the several pressure sensors are divided into a first sensing unit, a second sensing unit, a third sensing unit, a fourth sensing unit, a fifth sensing unit, a sixth sensing unit, a seventh sensing unit, a eighth sensing unit and a ninth unit, the first sensing unit, the second sensing unit, the third sensing unit, the fourth sensing unit, the fifth sensing unit, the sixth sensing unit, the seventh sensing unit, the eighth sensing unit and the ninth unit are connected to the multiplexer by the first connecting line, the second connecting line, the third connecting line, the fourth connecting line, the fifth connecting line, the sixth connecting line, the seventh connecting line, the eighth connecting line and the ninth connecting line respectively.

7. The fingerprint identification device of claim 6, wherein each of the first sensing unit, the second sensing unit, the third sensing unit, the fourth sensing unit, the fifth sensing unit, the sixth sensing unit, the seventh sensing unit, the eighth sensing unit and the ninth unit comprises multiple pressure sensors.

8. An electronic device comprising:
a shell comprising two opposite sides and defining a groove on one of the sides;
a display panel located on another one of the sides of the shell opposite to the groove;
a back board housed in the groove of the shell; and
a fingerprint identification device located in the back board, and comprising a pressure sensor array, a multiplexer, an addressing circuit, a signal processing circuit, a microcontroller and a memory, the multiplexer is connected to the pressure sensor array and the signal processing circuit; the microcontroller is connected to the signal processing circuit and the memory; the addressing circuit is connected to the multiplexer and the microcontroller; the microcontroller comprises a timing unit, a location identification unit, an image processor and a comparing unit, the timing unit, the location identification unit and the image processor are used to process electrical signals received by the microcontroller to gain location information, fingerprint images, durations, and a set of fingerprint information comprising the location information, the fingerprint images and the durations corresponding to the electrical signal; in fingerprint identification, the comprising unit comprise all the fingerprint information corresponding to the electrical signals with preset fingerprint information stored in the memory in turn, the microcontroller gives out a fingerprint identification confirmation or fingerprint unconformable information according to the comparison result gained by the comparing unit.

9. The electronic device of claim 8, wherein the microcontroller controls the multiplexer to process in multiplex sets by the addressing circuit.

10. The electronic device of claim 9, wherein the signal processing circuit transfers the pressure information received by the pressure sensor array into electrical signal and sends the electrical signal to the microcontroller, the timing unit of the microcontroller records duration of the pressure signal corresponding to the electrical signal, the location identification unit processes the electrical signal to gain a location information of pressure sensors of the pressures sensor array that sense the pressure signal, the image processor processes the electrical signal to gain a fingerprint image of the finger acted on the pressures sensor array.

11. The electronic device of claim 10, wherein the comparing unit comprises a time comparison module, a location comparison module and an image comparison module, the preset fingerprint information stored in the memory comprises preset time information, preset location information, and preset fingerprint image, the time comparison module compares the duration of the pressure signals with the present time information stored in the memory, the location comparison module compares the location information of the pressure sensors that senses the pressure signals with the present location information stored in the memory, the image comparison module compares the fingerprint image with the present fingerprint image stored in the memory.

12. The electronic device of claim 8, wherein the pressure array comprises several pressure sensors, a first connecting line, a second connecting line, a third connecting line, a fourth connecting line, a fifth connecting line, a sixth connecting line, a seventh connecting line, a eighth connecting line and a ninth connecting line, the several pressure sensors are arranged to a m×n matrix.

13. The electronic device of claim 12, wherein the several pressure sensors are divided into a first sensing unit, a second sensing unit, a third sensing unit, a fourth sensing unit, a fifth sensing unit, a sixth sensing unit, a seventh sensing unit, a eighth sensing unit and a ninth unit, the first sensing unit, the second sensing unit, the third sensing unit, the fourth sensing unit, the fifth sensing unit, the sixth sensing unit, the seventh sensing unit, the eighth sensing unit and the ninth unit are connected to the multiplexer by the first connecting line, the second connecting line, the third connecting line, the fourth connecting line, the fifth connecting line, the sixth connecting line, the seventh connecting line, the eighth connecting line and the ninth connecting line respectively.

14. The electronic device of claim 13, wherein each of the first sensing unit, the second sensing unit, the third sensing unit, the fourth sensing unit, the fifth sensing unit, the sixth sensing unit, the seventh sensing unit, the eighth sensing unit and the ninth unit comprises multiple pressure sensors.
